(19) United States
(12) Patent Application Publication
(10) Pub. No.: US 2014/0310735 A1
(43) Pub. Date: Oct. 16, 2014

(54) FLAT RATE BILLING OF CONTENT DISTRIBUTION

(71) Applicant: CODEMATE A/S, Kobenhavn K (DK)

(72) Inventors: Scott K. Brown, Marietta, GA (US); Michael Koehn Milland, Zionsville, IN (US); Robert J. Gribnau, Chapel Hill, NC (US); Theis Rauhe, Olstykke (DK)

(73) Assignee: CODEMATE A/S, Kobenhavn K (DK)

(21) Appl. No.: 14/250,971

(22) Filed: Apr. 11, 2014

Related U.S. Application Data
(60) Provisional application No. 61/811,235, filed on Apr. 12, 2013.

(51) Int. Cl. H04N 21/2543; G06Q 30/04

(52) U.S. Cl. CPC H04N 21/2543; G06Q 30/04
USPC 725/1

(57) ABSTRACT

The invention relates to flat rate billing schemes and ways of improving the cost-efficiency in the broadcasting of e.g. streaming media.

### CROSS REFERENCE TO RELATED APPLICATION

This application is related to and claims the benefit of U.S. Provisional Patent Application Ser. No. 61/811,235 filed on 12 Apr. 2013, the contents of which are herein incorporated by reference in their entirety.

### FIELD OF THE INVENTION

The present invention relates to content distribution in networks, primarily distribution of broadcast video feeds on the Internet and associated billing plans.

### BACKGROUND OF THE INVENTION

Distribution of streaming video accounts for a significant part of the data traffic and quality requirements to be considered by players in the Internet infrastructure business, as well as the broadcasters of video.

One concern from a technical point of view on the heavy data traffic is that the long proven unicasting model of distributing content from the broadcaster to each of the content recipients individually is requiring the same data to be transported several times along the same routes. This is entirely manageable on today's Internet infrastructure for smaller amounts of data such as websites, etc., but can become a real problem when the data is e.g. a popular high definition TV programme live stream being viewed by thousands of subscribers on the other side of the globe. FIG. 1 illustrates this scenario, where content recipients R each receives a video stream from a content broadcaster B via, typically, a content distributor CD, one or more intermediate networks IN and finally their local service provider network SPN, e.g. their telecommunications or internet service provider. Because of the broadcast being made by unicast connections UCC, e.g. HTTP-connections, this requires generally as many equal streams as there are recipients.

From a financial point of view the distribution of streaming video may also be disturbing. With reference to FIG. 2, the content recipients R typically pay their service provider network SPN for Internet access according to a flat rate plan (as illustrated by the contract with a dollar sign and a flat curve beside it). The content broadcaster, e.g. a broadcasting network or other streaming media provider, typically charges their subscribers, i.e. the content recipients, also according to a flat rate plan, or provide their media for free (as illustrated by the contract with the dollar sign having a prohibition sign covering it), possibly paid by advertisements or being part of a marketing strategy. However, the billing within the Internet infrastructure is typically made according to usage, e.g. charging for the number of bits being transported per month. So, the content distributor CD charges the content broadcaster B according to the amount of data transported (as illustrated by the contract with a dollar sign and a varying curve beside it), and possibly both the content distributor CD and the service provider network SPN are charged by the intermediate networks IN for transit according to usage. Now, when the e.g. thousands of subscribers on the other side of the globe watches this popular high definition TV programme live stream as mentioned above, requiring equal content to be transported thousands of times along the same route, the per-usage variable billing plans described above rise steeply.

One way to avoid transporting equal data thousands of times from a content broadcaster B to a service provider network SPN for distribution among content recipients R is illustrated in FIG. 3, where a content cache C has been placed in or near the service provider network SPN, so that the copying to several unicast streams is performed locally by the content cache C, and the content distributor CD only needs to unicast transport the stream once to the content cache. Comparing with the technical concerns described above, now the thousands of unicast streams only appears locally and need not be transported around the globe, and from the financial point of view, this means that the intermediate networks IN will only be charging the content distributor for a fraction of the usage before. This facilitates the content distributor CD in controlling and predicting the costs, thereby enabling more flexible and possibly cheaper billing plans for charging the content broadcaster, less dependent on the number of recipients. However, getting suitable caching arranged inside foreign networks may also be challenging on several levels for the content distributor CD.

### SUMMARY OF THE INVENTION

The invention relates to a method of providing a network content distribution service for delivering content from a content broadcaster to a service provider network to facilitate the service provider network to further distribute the content to content recipients; the method comprising
establishing a network content distribution service comprising
   delivering said content to the service provider network by multicast distribution, and
   providing a reserve distribution system to handle delivery errors of content occurring on the way to the content recipients;
billing the content broadcaster for using the network content distribution service according to a flat rate plan, the flat rate plan at least covering the distribution made by multicast distribution.

The present invention makes it possible to offer predictable billing plans to content broadcasters substantially regardless of the number of viewers of their content. This is a great step forward towards less expensive and most importantly, foreseeable, costs related to distributing popular content such as e.g. major TV or sports events, which may attract such high number of viewers around the world that it previously was practically and economically impossible to stream such events.

According to the present invention, multicast distribution may refer to any kind of multicast or multicast-like distribution methods. Preferably IP Multicast is implemented, but may also within the scope of the invention be entirely or partly other multicast or pseudo or combinative multicast methods such as e.g. automatic multicast tunneling usable for reaching content recipients where they themselves or network components along the route not being willing or controllable or able to enable native multicast. Multicast distribution may within the scope of the invention further comprise several multicast streams, either copies or differently coded or parted versions of the content. Multicast distribution may further according to the invention comprise a relatively insignificant part of either end of the route being implemented by any other transport method, including unicast, for example for transporting the content stream from the content broadcaster to a first multicast capable network component, e.g. server or router, or for transporting the content stream from a multicast termination point to remaining way to a content recipient.

The reserve distribution system provides redundancy and/or resiliency to e.g. loss of packets in the multicast distribution. According to the invention the reserve distribution system may comprise any suitable resiliency or redundancy, preferably copies of the multicast stream, alternative routes, alternative multicast source location, loss resilient coding techniques, grid technology or other peer-to-peer technology distribution of content, content caching, retransmission servers, etc.

A flat rate plan comprises according to the invention a way of billing for streaming media distribution, where the billed amount is relatively fixed when compared to billing schemes of previous distribution methods, preferably with respect to the amount of bits being handled or the number of content recipients, preferably at least with respect to the amount of bits being handled by the multicast distribution. A staircase flat rate plan with a few different flat rate levels for a few intervals of significantly different amounts content recipients or of transported bits is considered a flat rate plan according to the invention. A flat rate plan with different rates depending on the number of channels streamed, e.g. the number of TV channels served, the number of streams of different video quality offered for each channel, the geographical scattering of subscribers due to the more scattering the more copies to different places required, the scattering of subscribers among service provider networks SPN as mentioned above, etc. is considered a flat rate plan within the scope of the invention, with respect to the amount of bits and recipients. Also billing plans that are substantially flat with respect to number of recipients or transmitted bits but include an insignificant amount being variable, or pre-paid data package plans which essentially covers, corresponds to, or practically work like a flat-rate plan, are also considered within the scope of a flat-rate plan according to the present invention.

An advantageous embodiment of the present invention is obtained when the content is streaming media.

An advantageous embodiment of the present invention is obtained when the method comprises optionally further billing the content broadcaster according to a usage based plan based on the extent of usage of the reserve distribution system.

An advantageous embodiment of the present invention is obtained when the reserve distribution system enables the multicast distribution to be made via best effort internet access network.

In a preferred embodiment of the invention, the reserve distribution system is implemented with such efficiency as to be able to successfully support a lossy multicast distribution such as unreliable multicast methods performed via the typical best effort network internet infrastructure used by average streaming media content recipients. This advantage of the present invention is in contrast to previous successful multicast distribution attempts, e.g. as widely deployed for IP TV, which requires dedicated multicast networks not subject to QoS restrictions regarding low throughput or retransmission facilities in limited networks with full control over components, configurations, QoS, etc. Such possibilities cannot be obtained and expected from all network components on the route when transporting by different best effort internet infrastructure providers.

An advantageous embodiment of the present invention is obtained when less than 50% of bits sent to the service provider network are sent by the reserve distribution system.

An advantageous embodiment of the present invention is obtained when less than 20% of bits sent to the service provider network are sent by the reserve distribution system.

An advantageous embodiment of the present invention is obtained when the reserve distribution system comprises an alternative multicast distribution.

An advantageous embodiment of the present invention is obtained when the reserve distribution system comprises a loss resilient coding of said content.

An advantageous embodiment of the present invention is obtained when the reserve distribution system comprises distribution of loss resilient coding of said content by grid technology.

An advantageous embodiment of the present invention is obtained when the reserve distribution system comprises a retransmission facility for the content recipients to request packets lost in the multicast distribution.

An advantageous embodiment of the present invention is obtained when the reserve distribution system comprises content caching.

An advantageous embodiment of the present invention is obtained when the reserve distribution system enables the multicast distribution to be made via best effort internet access network and wherein the delivering content comprises distributing IP TV to the content recipients.

In a preferred embodiment of the invention, the method is used for IP TV distribution over standard best effort internet access networks made possible by the reserve distribution system. The telecommunication service provider or internet service provider is thereby enabled to offer IP TV distribution to their customers, i.e. the content recipients, without having to setup a dedicated, provisioned multicast network, e.g. with special QoS restrictions regarding low throughput or retransmission facilities. This also means that the service provider can avoid taking measures for reserving a part of the bandwidth to IP TV, as the TV distribution by means of the present invention simply becomes part of the bulk of data transported to the content recipients with no special handling apart from the common enabling of multicast and managing an efficient reserve distribution system according to the invention. In an embodiment of the invention, the content broadcaster is located in the service provider network, e.g. a telecommunication service provider broadcasting IP TV within its own network. In this case, the main task of the network content distribution service is the provision of the reserve distribution system, which is also a key parameter in getting multicast distribution to work on a best effort network.
The present invention further relates to a method for improving cost-efficiency in delivering content from a content broadcaster to a service provider network, facilitating the service provider network to further distribute the content to content recipients; the method comprising
enabling multicast distribution within the service provider network and delivering said content to the service provider network by multicast distribution, thereby reducing costs of data transport to the service provider network; and
providing a reserve distribution system to handle delivery errors of content occurring on the way to the content recipients, thereby improving efficiency of the data transport to the service provider network.

The present invention improves the cost-efficiency related to distribution of e.g. streaming media within a service provider network, e.g. to media content recipients. Conventionally, streaming media are distributed by connection-oriented methods such as TCP, which generally causes the amount of data handled by the service provider network to become proportional to the number of its subscribers viewing the content simultaneously. This puts heavy requirements on the service provider network support and investments, and the streaming media part of internet data is quickly getting a significant, even major, part of the total amount of data being sent around on the Internet. In other words, the previous methods may be efficient, but only if tremendous investments are made in maintaining an infrastructure with sufficient capacity. Another approach has been to invest in dedicated infrastructure for streaming media distribution, also causing further investments, and making the remaining use of the internet less efficient.

By the present invention this is overcome by having the service provider network enable multicast distribution in their standard, best effort network provided to typical content recipients. The enablement of multicast may according to the present invention drastically reduce the amount of data received for further distribution to the content recipients, as they by the new invention will be able to share a single or a few multicast feeds. Further, according to the present invention, efficiency is also facilitated by providing a reserve distribution system arranged to correct packet losses occurring in the multicast stream. The reserve distribution system according to the present invention is efficient enough to make it feasible to open up for the unreliable multicast distribution. Altogether, the service provider networks, e.g. telecommunication service providers or Internet service providers experience an improved cost-efficiency by implementing the present invention, which is considered sufficient to make them interested in doing the typically trivial job of enabling multicast distribution in their network components.

Besides lowering the costs and making them more predictable, the present invention facilitates the service providers in offering better service and higher quality to their end users, as for example higher data rates, faster start-up time of a video stream, higher availability, less buffering and buffer-related interruptions, higher video quality in terms of e.g. resolution and compression, etc. become possible and more affordable to provide. The released resources and/or costs may also be used to offer a higher number of streams of different qualities of the same content to better match the different wishes and requirements of different end-users. The present invention also enhances the possibilities for offering adaptive bitrate much more seamlessly and less noticeable for the end-user than conventional methods because of the possibility to obtain measurements or try different options in the background due to the reserve distribution system. A larger selection of streams of different bitrates that can be switched in and out more or less unnoticed to always and adaptively provide the best possible quality to a certain end-user, with no hassle for him or her, is a great advantage over conventional Internet media streaming.

A service provider network participating in a setup according to the present invention may e.g. exploit the above-described advantages in their marketing as a differentiating parameter from other service providers or to offer the same service cheaper, and/or they may e.g. exploit the advantages for optimizing their infrastructure.

According to the present invention, multicast distribution may refer to any kind of multicast or multicast-like distribution methods. Preferably IP Multicast is implemented, but may also within the scope of the invention be entirely or partly other multicast or pseudo or combinative multicast methods such as e.g. automatic multicast tunneling usable for reaching content recipients where they themselves or network components along the route not being willing or controllable or able to enable native multicast. Multicast distribution may within the scope of the invention further comprise several multicast streams, either copies or differently coded or parted versions of the content. Multicast distribution may further according to the invention comprise a relatively insignificant part of either end of the route being implemented by any other transport method, including unicast, for example for transporting the content stream from the content broadcaster to a first multicast capable network component, e.g. server or router, or for transporting the content stream from a multicast termination point to remaining way to a content recipient.

The reserve distribution system provides redundancy and/or resiliency to e.g. loss of packets in the multicast distribution. According to the invention the reserve distribution system may comprise any suitable resiliency or redundancy, preferably copies of the multicast stream, alternative routes, alternative multicast source location, loss resilient coding techniques, grid technology or other peer-to-peer technology distribution of content, content caching, retransmission servers, etc.

An advantageous embodiment of the present invention is obtained when the content is streaming media.

An advantageous embodiment of the present invention is obtained when the reserve distribution system enables the multicast distribution to be made via best effort internet access network.

In a preferred embodiment of the invention, the reserve distribution system is implemented with such efficiency as to be able to successfully support a lossy multicast distribution such as unreliable multicast methods performed via the typical best effort network internet infrastructure used by average streaming media content recipients. This advantage of the present invention is in contrast to previous successful multicast distribution attempts, e.g. as widely deployed for IP TV, which requires dedicated multicast networks not subject to QoS restrictions regarding low throughput or retransmission facilities in limited networks with full control over components, configurations, QoS, etc. Such possibilities cannot be obtained and expected from all network components on the route when transporting by different best effort internet infrastructure providers.

An advantageous embodiment of the present invention is obtained when less than 50% of bits sent to the service provider network are sent by the reserve distribution system.

An advantageous embodiment of the present invention is obtained when less than 20% of bits sent to the service provider network are sent by the reserve distribution system.

An advantageous embodiment of the present invention is obtained when the reserve distribution system comprises an alternative multicast distribution.

An advantageous embodiment of the present invention is obtained when the reserve distribution system comprises a loss resilient coding of said content.

An advantageous embodiment of the present invention is obtained when the reserve distribution system comprises distribution of loss resilient coding of said content by grid technology.

An advantageous embodiment of the present invention is obtained when the reserve distribution system comprises a retransmission facility for the content recipients to request packets lost in the multicast distribution.

An advantageous embodiment of the present invention is obtained when the reserve distribution system comprises content caching.

An advantageous embodiment of the present invention is obtained when the reserve distribution system enables the multicast distribution to be made via best effort internet access network and wherein the method for improving cost-efficiency is used for distributing IP TV to the content recipients.

In a preferred embodiment of the invention, the method is used for IP TV distribution over standard best effort internet access networks made possible by the reserve distribution system. The telecommunication service provider or internet service provider is thereby enabled to offer IP TV distribution to their customers, i.e. the content recipients, without having to setup a dedicated, provisioned multicast network, e.g. with special QoS restrictions regarding low throughput or retransmission facilities. This also means that the service provider can avoid taking measures for reserving a part of the bandwidth to IP TV, as the TV distribution by means of the present invention simply becomes part of the bulk of data transported to the content recipients with no special handling apart from the common enabling of multicast and managing an efficient reserve distribution system according to the invention. In an embodiment of the invention, the content broadcaster is located in the service provider network, e.g. a telecommunication service provider broadcasting IP TV within its own network. In this case, the main task of the network content distribution service is the provision of the reserve distribution system, which is also a key parameter in getting multicast distribution to work on a best effort network.
The present invention further relates to a method of providing a network content distribution service for delivering content from a content broadcaster to a service provider network to facilitate the service provider network to further distribute the content to content recipients; the method comprising
establishing a network content distribution service comprising
   delivering said content to a content cache connected to the service provider network, and
   providing a reserve distribution system to handle delivery errors of content occurring on the way to the content recipients;
billing the content broadcaster for using the network content distribution service according to a flat rate plan, the flat rate plan at least covering distribution of the content from the content cache.

The present invention makes it possible to offer predictable billing plans to content broadcasters substantially regardless of the number of viewers of their content. This is a great step forward towards less expensive and most importantly, foreseeable, costs related to distributing popular content such as e.g. major TV or sports events, which may attract such high number of viewers around the world that it previously was practically and economically impossible to stream such events.

According to the present invention, a content cache is placed in or near a service provider network so that the content only has to be transported to the service provider network once, and may then be distributed to content recipients from the content cache. Thereby the transit usage is drastically reduced, making it feasible to offer a flat rate plan to the content broadcaster. The distribution of content from the content cache may be made by multicast distribution or loss resilient grid technology, making the content distribution even less demanding for the service provider network.

The reserve distribution system provides redundancy and/or resiliency to e.g. loss of packets in a multicast distribution from the content cache. According to the invention the reserve distribution system may comprise any suitable resiliency or redundancy, preferably copies of the multicast stream, alternative routes, alternative multicast source location, loss resilient coding techniques, grid technology or other peer-to-peer technology distribution of content, content caching, retransmission servers, etc.

A flat rate plan comprises according to the invention a way of billing for streaming media distribution, where the billed amount is relatively fixed when compared to billing schemes of previous distribution methods, preferably with respect to the amount of bits being handled or the number of content recipients, preferably at least with respect to the amount of bits being transmitted to the content cache. A staircase flat rate plan with a few different flat rate levels for a few intervals of significantly different amounts content recipients or of transported bits is considered a flat rate plan according to the invention. A flat rate plan with different rates depending on the number of channels streamed, e.g. the number of TV channels served, the number of streams of different video quality offered for each channel, the geographical scattering of subscribers due to the more scattering the more copies to different places required, the scattering of subscribers among service provider networks SPN as mentioned above, etc. is considered a flat rate plan within the scope of the invention, with respect to the amount of bits and recipients.

An advantageous embodiment of the present invention is obtained when the content is streaming media.

An advantageous embodiment of the present invention is obtained when the method comprises optionally further billing the content broadcaster according to a usage based plan based on the extent of usage of the reserve distribution system.

An advantageous embodiment of the present invention is obtained when the distribution of content from the content cache to the content recipients is made by multicast distribution.

An advantageous embodiment of the present invention is obtained when the distribution of content from the content cache to the content recipients is made by loss resilient grid technology.

An advantageous embodiment of the present invention is obtained when the reserve distribution system enables the multicast distribution to be made via best effort internet access network.

In a preferred embodiment of the invention, the reserve distribution system is implemented with such efficiency as to be able to successfully support a lossy multicast distribution such as unreliable multicast methods performed via the typical best effort network internet infrastructure used by average streaming media content recipients. This advantage of the present invention is in contrast to previous successful multicast distribution attempts, e.g. as widely deployed for IP TV, which requires dedicated multicast networks not subject to QoS restrictions regarding low throughput or retransmission facilities in limited networks with full control over components, configurations, QoS, etc. Such possibilities cannot be obtained and expected from all network components on the route when transporting by different best effort internet infrastructure providers.

An advantageous embodiment of the present invention is obtained when the reserve distribution system comprises a multicast distribution.

An advantageous embodiment of the present invention is obtained when the reserve distribution system comprises a loss resilient coding of said content.

An advantageous embodiment of the present invention is obtained when the reserve distribution system comprises distribution of loss resilient coding of said content by grid technology.

An advantageous embodiment of the present invention is obtained when the reserve distribution system comprises a retransmission facility for the content recipients to request packets lost in the distribution from the content cache.

### THE DRAWINGS

The invention will in the following be described with reference to the drawings where

FIG. 1 illustrates a prior art unicast distribution scenario,

FIG. 2 illustrates a prior art business scheme for a unicast distribution scenario,

FIG. 3 illustrates a prior art cached distribution scenario,

FIG. 4 illustrates an embodiment of the present invention featuring multicast distribution and a reserve distribution system,

FIG. 5 illustrates an embodiment of a business method according to the present invention,

FIG. 6 illustrates an embodiment of the present invention featuring multicast distribution and a reserve distribution system,

FIG. 7 illustrates an embodiment of the present invention featuring a reserve multicast stream distributor at the content distributor as a reserve distribution system,

FIG. 8 illustrates an embodiment of the present invention featuring a reserve multicast stream distributor in the service provider network as a reserve distribution system,

FIG. 9 illustrates an embodiment of the present invention featuring grid technology as reserve distribution system, and

FIG. 10 illustrates an embodiment of the present invention featuring content caching locally in the service provider network.

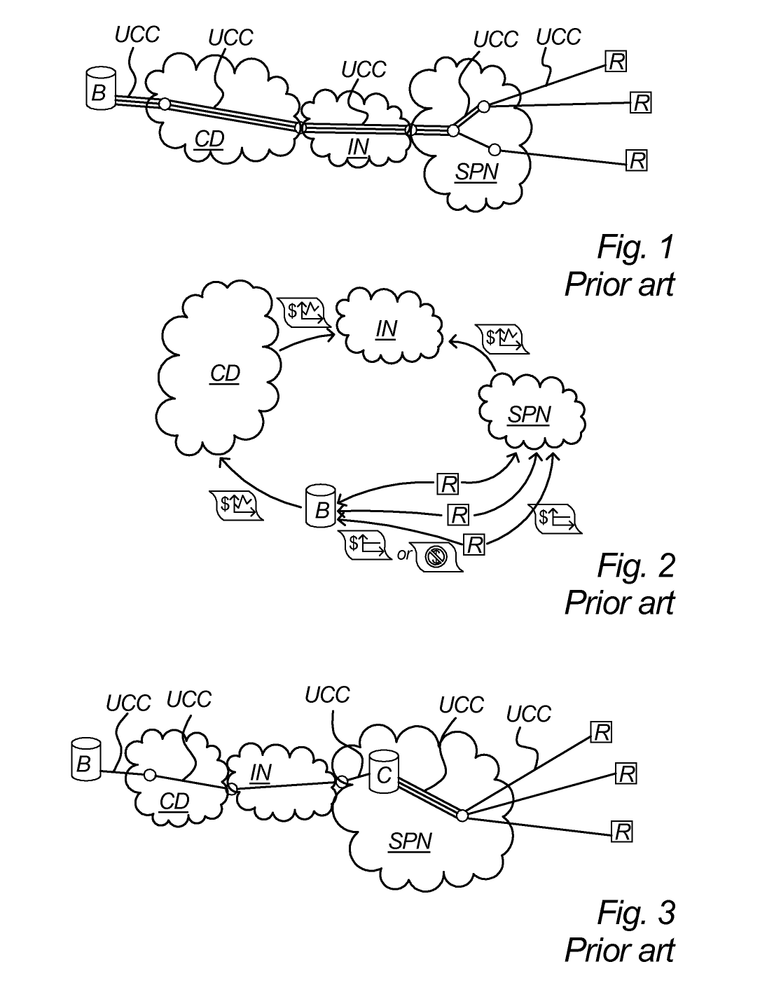

### DETAILED DESCRIPTION

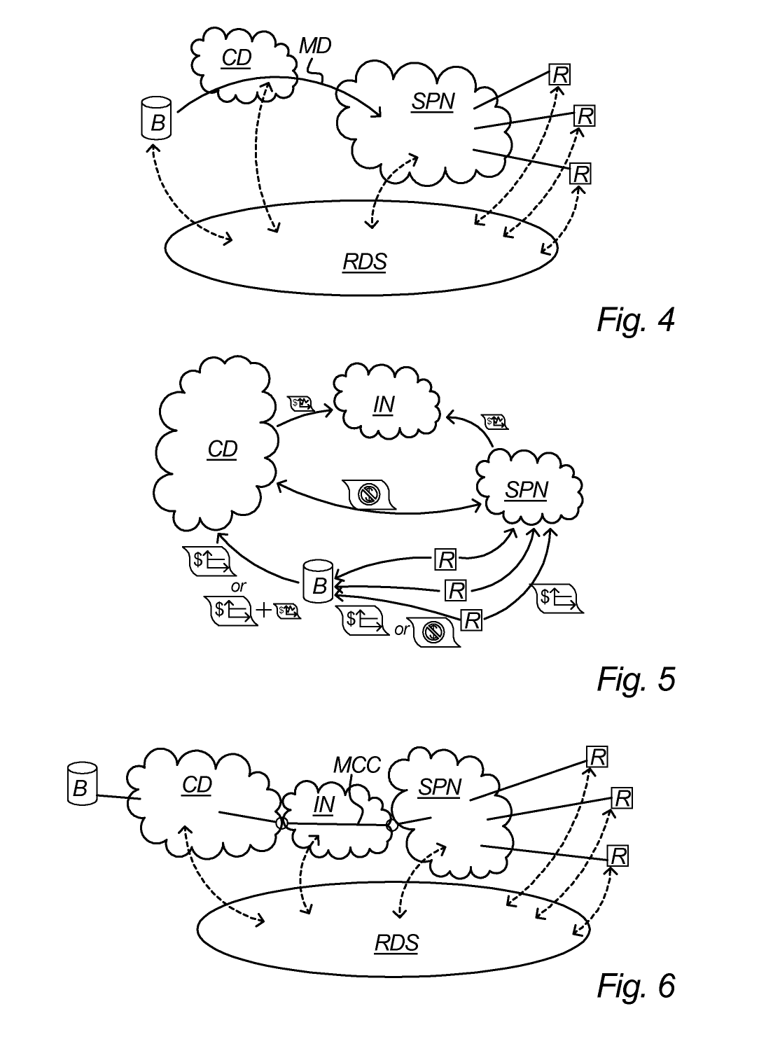

FIG. 4 illustrates an embodiment of the invention where a content broadcaster B delivers content to a service provider network SPN by means of multicast distribution MD managed by a content distributor CD. A number of content recipients R are connected to the service provider network SPN and may eventually receive the content delivered to that network. Further, the embodiment of FIG. 4 comprises a reserve distribution system RDS that is arranged to correct packet losses in the multicast distribution MD and possible also the further distribution to the content recipients. The reserve distribution system RDS may be connected to the main distribution system at one or more locations, for example a number of the locations illustrated with dashed curves bi-directional to and/or from the reserve distribution system RDS.

The reserve distribution system RDS may be implemented according to one or more of several different distribution technologies, including combinations thereof. Preferred and example alternative embodiments of reserve distribution systems are described in the following.

The multicast distribution MD may according to the present invention comprise any way of distributing content where some parts or all parts of the stream are delivered by a multicast-like protocol or technology, preferably by native multicast and/or automatic multicast tunneling. The multicast distribution MD may comprise one or more multicast streams, possibly including redundant or resiliency information out of band, etc. In a preferred embodiment, the multicast distribution MD is arranged and carried out by a network content distribution service provider CDS.

The content broadcaster B may represent a single broadcast server, but may as well within the scope of the invention comprise several servers, possibly at different locations. The distribution from the content broadcaster is managed by a content distributor CD, which may comprise a single server or several servers, possible located at different positions, e.g. forming a content delivery network CDN or the like. The content distributor may comprise more or less of network infrastructure components such as routers, caches, etc., and may have a single point of presence POP, or be represented by POPs in several locations.

The way from the content distributor CD to the service provider network SPN may involve direct connection there between, but may within the scope of the invention go through intermediate networks, routers, servers, etc., as well.

The service provider network SPN may within the scope of the invention preferably refer to an infrastructure of an internet service provider, telecommunications service provider, cable company or other structure who provides the so-called last-mile infrastructure for enabling the content receivers R, the end users, to connect to the Internet or other network through which the content distributor CD can, possibly indirectly, deliver the content.

The present invention is particularly useful when the content is media streaming to be received by several recipients more or less simultaneously, like e.g. TV shows, but may according to configuration also be beneficial for on-demand video streaming or download, or streaming or download of other kinds of data, e.g. databases, live gaming data, file exchange, live data sharing, e.g. of recurring measurement data or ongoing calculation results, etc.

FIG. 5 illustrates with an embodiment of the present invention how a content distribution arrangement as illustrated in FIG. 4 typically involves a number of agreements, billing plans, etc. due to the different legal entities cooperating in getting the content from the content broadcaster B to the content recipients R. The content broadcaster B, say, a TV programming network, may be free to watch for a content recipient R, or the content broadcaster may charge, e.g. a flat rate subscription fee. The content recipients R typically also pay their service provider network SPN, e.g. their telecommunication or internet service provider, according to a flat rate plan. The intermediate networks IN still typically charges the content distributor and the service provider network for transit in accordance with their usage, but with the present invention, preferably using multicast distribution MD, the amount of data in transit, and thereby the bills, become significantly smaller and more predictable than with the distribution methods described above as background art. Alternatively, the content distributor and the service provider network may enter into a settlement-free peering agreement for mutual benefit, thus avoiding some or all of the transit costs.

As for the transport of content from the content broadcaster B to the service provider network SPN, the multicast backbone MD of a preferred embodiment of the present invention therefore makes it feasible for the content distributor CD to offer a so-called flat rate plan, at least for a part of the billing, as indicated in FIG. 5. Ideally, a content distributor, e.g. a content delivery network, offering a multicast distribution scheme, only needs to transport one copy of the content through the network and deliver it to the service provider network SPN. In case of several service provider networks, only one copy for each needs to be transported. In other words, the number of copies varies with the number of service provider networks SPN, e.g. telecommunication service providers or internet service providers. Hence, the copying of the content to each end user takes place locally in the service provider network, preferably as close to the end user termination points as possible.

This is in deep contrast to the unicast transport schemes e.g. as described above as background art, where the network content distributor needs to transport a copy for each separate end user requesting the content, and the number of copies handled by the distributor therefore varies with the number of end users. Besides accumulating copies of the content, the dependency of the number of end users also means, that it gets quite unpredictable how many copies are going to be transported, as the content distributor may not have access to user data from neither the content broadcaster, nor the service provider networks.

By only having to transport the content once to each service provider network as opposed to each end user, the distributor in an embodiment of the invention bills the content broadcaster according to a flat rate plan, i.e. a plan that does not depend directly on the number of viewers to the content as the typical per-usage plans do.

The flat rate plan may within the scope of the invention vary with one or more of the number of e.g. TV channels served, the number of streams of different video quality offered for each channel, the geographical scattering of subscribers due to the more scattering the more copies to different places required, the scattering of subscribers among service provider networks SPN as mentioned above, etc.

The business method of the present invention may in another embodiment consist of a flat rate billing component as described above, combined with a variable per use charge for covering instances where the reserve distribution system RDS has to step in and correct a lost or otherwise faulty transport of a part of the stream transported by multicast distribution MD as describe above. Depending on the technology used for the reserve distribution system RDS the additional costs related thereto may be more or less costly, more or less predictable and more or less controllable, as described further below in relation to examples of reserve distribution system implementations. In preferred embodiments of the invention, unicast traffic, mainly for the reserve distribution system RDS, accounts for as little as 10-15% of the entire data traffic that the content distributor CD handles. As the unicast traffic represents the most unpredictable and recipient-dependent part of the traffic, the fact that the unicast fraction can be kept so low by the present invention, causes the entire data traffic amount to be quite predictable and independent of the number of viewers. This feature makes it reasonable to make billing simple and predictable for the content distributor's customer, i.e. the content broadcaster, by offering either a flat rate plan where the small unpredictability have been evened out, or a flat rate plan combined with a per-usage plan, preferably having the per-usage plan account for less than 25%, or in optimal systems, less than 10-15%, of the total amount billed.

In order to facilitate the multicast distribution scheme, the service provider network SPN should enable multicast handling, at least multicast of the type used in a specific implementation by the service provider. Multicast is, however, typically disabled by the service provider networks. Therefore, the business method of the present invention involves establishing an agreement with the relevant service provider networks that they enable multicast traffic in their infrastructure. As practically most network equipment supports multicast if just enabled, appliance to this term is straightforward in the service provider networks. Besides typically being unproblematic, the enablement of multicast distribution according to the present invention in fact also benefits the service provider networks SPN. They are relieved from the heavy data traffic related to relaying an individual copy of the content to each of the subscribers, for both practical and financial benefit. A direct, positive consequence of a lot of network resources being released by changing to multicast distribution is that the service provider network may begin supporting distribution of even heavier streams with higher video quality, to the subscriber's benefit, and/or support distribution to even more subscribers without expanding the network resources. Hence, the service providers SPN are typically going to be interested in offering to enable and serve the multicast content to their subscribers.

Various forms of multicast distribution have been attempted before, but they have only been successful inside limited, optimized, dedicated multicast networks where full control over quality of service QoS, router features and settings, etc. can be guaranteed. For the network service provider SPN this has typically meant, that if they wanted to provide multicast distribution of e.g. IP TV, they would need to arrange a separate, provisioned infrastructure and guarantee a certain bandwidth for each subscriber to that purpose.

With the present invention, the multicast distribution becomes a feasible possibility even in most of the typical best effort network infrastructures used for the Internet, including the network service providers SPN who with the reserve distribution system RDS features of the present invention need only turn the typically existing multicast feature on, and optionally limiting it to relevant multicast group addresses if concerned about multicast abuse.

A main reason for multicast methods generally not being a success until now is the lack of reliable and fast ways for recipients who for some reason missed a packet, to get hold of it anyway. As multicast methods are inherently unreliable, and if used for transmitting streaming media through different best effort networks over long distances, packet losses are inevitable.

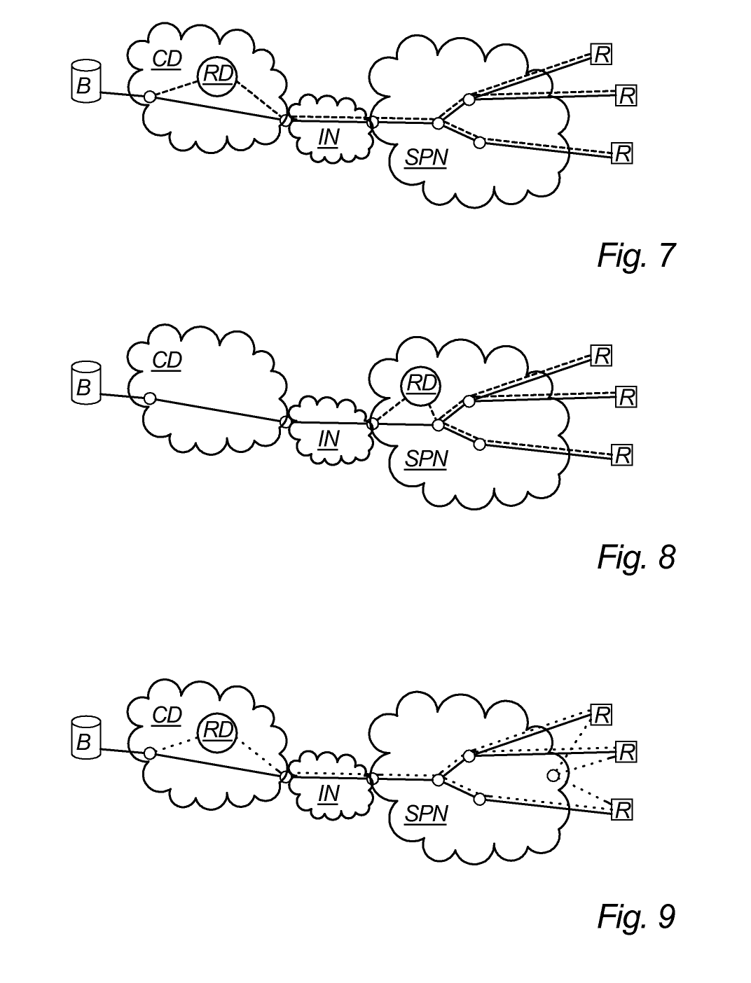

FIG. 7 illustrates an embodiment of the invention with multiple copies of the multicast stream acting as reserve distribution system. The content distributor CD is managing a multicast distribution (shown in solid lines) of a media stream from the content broadcaster B through intermediate networks IN to the service provider network SPN, where it is distributed to content recipients R. The embodiment further comprises a reserve distributor RD, possibly implemented in a router, a server or other network component, which receives the content either directly from the content broadcaster, or from within the content distributor CD, and provides the content as one or more multicast streams (shown in dashed lines) in addition to the main multicast stream. Content recipients R, or network components making multicast streams available to non-multicast recipients, may subscribe to both the main multicast group and the one or more reserve distribution multicast groups. The reserve distribution multicast stream(s) of the embodiment of FIG. 7 makes the content distribution more resilient, by increasing the chance that each packet is received from at least one of the streams. There may be several reserve distributors RD in a reserve distribution system according of the present invention.

In an alternative embodiment, the reserve distributor RD does not transmit the reserve multicast stream(s) continuously, but only transmits packets that are requested by content recipients R or other network components downstream from the reserve distributor RD, e.g. automatic multicast tunneling routers. Due to the nature of multicast, a packet loss anywhere else than in the very last network leg to a content recipient, will cause missing packets at several content recipients, therefore making it reasonable to multicast the requested retransmissions for all recipients to have.

In an alternative embodiment, the reserve distributor RD does not multicast requested retransmission, but retransmits requested packets directly to the requesting content recipients by unicast methods, possibly even reliable unicast such as e.g. TCP.

In an alternative embodiment, the multicast or unicast transmission from the reserve distributor RD does not necessarily follow the same routes as the main multicast transmission from the content distributor CD to the content recipients R, but may by chance or deliberately travel by alternative routes.

FIG. 8 illustrates an embodiment of the invention with multiple copies of the multicast stream acting as reserve distribution system as in FIG. 7, but in the embodiment of FIG. 8, the reserve distributor RD is located within the service provider network SPN. The source stream for the reserve distributor RD to make resiliency stream(s) from may e.g. be the main multicast stream, or it may be a unicast, possibly by reliable methods, from the content distributor CD to the reserve distributor RD. As the number of reserve distributors RD should be low compared to the number of content recipients R, it may often be possible to unicast the content, possibly even reliably, to the reserve distributors RD to decrease the risk of missing packets at the reserve distributors. There may be several reserve distributors RD in a reserve distribution system RDS according to the invention. The several reserve distributors RD may be placed in each of several service provider networks served, one or more in each, possibly depending on geographical distances and network reliabilities, and/or they may be located in one or more intermediate networks IN, either the same as used by the main stream, or in intermediate networks on alternative routes for increased reliability and redundancy.

The alternative embodiments described above for the embodiment of FIG. 7 regarding using the reserve distributors RD for only multicasting on request or simply unicasting retransmissions may also apply to embodiments as described above with reference to FIG. 8.

FIG. 9 illustrates an embodiment of the invention where the reserve distribution system uses grid technology to distribute redundant resiliency data that the content recipients can gather to recreate packets from the main multicast stream. One or more reserve distributors RD located anywhere accessible from the content recipients R and the content distributor CD, in FIG. 9 illustrated as being located by the content distributor, obtains the content to be broadcast, either from the main multicast stream or by other means, e.g. as described above with reference to FIG. 7. The reserve distributor RD of the embodiment of FIG. 9 uses loss resilient coding schemes to distribute packets representing forward error correction codes, e.g. erasure codes, to some or all of the content recipients R (a possible distribution of loss resilient packets is illustrated by dotted lines). By means of grid technology, the content recipients exchange the loss resilient packets and ends up with a sufficient number of code packets to recover packets lost from the main multicast stream. The some or all content recipients may be exchanging code packets continuously, or may reduce the grid activity if no content recipients request packets for regenerating lost multicast stream packets. The erasure codes may e.g. be based on Reed-Solomon codes, Tornado codes, LT codes, or any other suitable, loss resilient coding technique. In a preferred embodiment the reserve distribution system RDS implements one of the embodiments of resilient media streaming grid technology that are disclosed in U.S. Pat. No. 7,581,158 to Alstrup et al., the entire disclosure of the mentioned patent hereby incorporated by reference. The loss resilient packets are preferably distributed by unreliable methods such as UDP unicast, but may alternatively be distributed by reliable methods such as TCP unicast, or by multicast.

In an alternative embodiment of the invention, the main content stream illustrated by solid lines is distributed by the loss resilient coding techniques described above, instead of, or in addition to, multicast distribution. If loss resilient coding is used for the main distribution, the reserve distribution system according to the invention may be considered inherent in the loss resilient main distribution, or a separate reserve distribution system e.g. based on multicast or loss resilient coding as described above, or caching as described below, may be provided. Even with the loss resilient grid technology for main distribution, the bandwidth savings through the intermediate networks may be enough to make it feasible to offer the content broadcaster a pure or combined flat rate billing plan as described above with reference to FIG. 5.

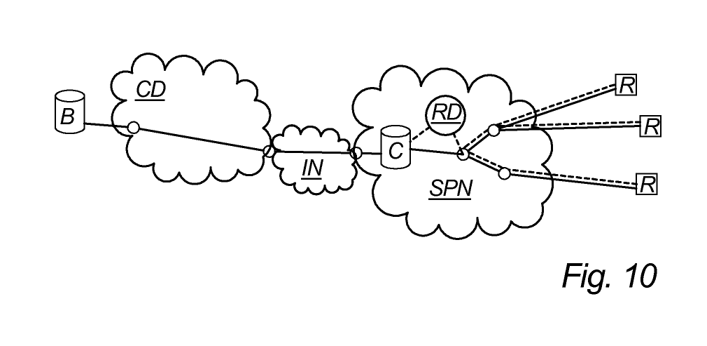

FIG. 10 illustrates an embodiment of the present invention where a content cache C is located in the service provider network SPN. The content cache is preferably managed by the content distributor CD and placed in the service provider network SPN, preferably under a settlement-free peering agreement, or it may be managed by the service provider network. The content cache is provided with the content from the content broadcaster B, for example by means of reliable unicast, but could also be unreliable unicast or multicast, possibly through intermediate networks IN.

The content cache C may preferably distribute the content to the content recipients R local to the service provider network SPN, preferably by multicast or grid technology, as described above, mutatis mutandis. A reserve distribution system may be implemented locally for the service provider network as illustrated in FIG. 9, e.g. by redundantly multicasting the content, or utilizing any of the other reserve distribution techniques described herein, including loss resilient coding.

In an alternative embodiment the content cache is located in a different service provider network or an intermediate network, preferably serving the illustrated service provider network according to a settlement-free peering agreement.

In an alternative embodiment the reserve distribution system is located upstream from the service provider network or in a different service provider network or intermediate network, possibly serving reserve distribution to several content recipients from this and other service provider networks.

By serving the possibly numerous content recipients R from a local content cache, the bandwidth savings through the intermediate networks may be enough to make it feasible to offer the content broadcaster a pure or combined flat rate billing plan as described above with reference to FIG. 5, when implementing one of the cache embodiments as described above.

In an alternative embodiment, a content cache as described above may implement the reserve distribution system in an embodiment with multicast main stream or any other of the embodiments described above. The content cache may in this embodiment implement any of the above-described reserve distribution systems, or it may simply retransmit packets to content recipients requesting retransmission of lost packets. By the local presence of the content cache this straightforward, connection-oriented unicast retransmission facility becomes more feasible both financially and practically than if placed farther upstream.

It is noted, that in all embodiments described herein where multicast is used, preferably IP Multicast is implemented, but may also within the scope of the invention be other multicast or pseudo or combinative multicast methods such as e.g. automatic multicast tunneling usable for reaching content recipients where they themselves or network components along the route not being willing or controllable or able to enable native multicast.

It is noted that combinations of different reserve distribution systems described above with each other or with other methods or technologies are within the scope of the invention.

1. A method of providing a network content distribution service for delivering content from a content broadcaster to a service provider network to facilitate the service provider network to further distribute the content to content recipients; the method comprising
establishing a network content distribution service comprising
delivering said content to the service provider network by multicast distribution, and
providing a reserve distribution system to handle delivery errors of content occurring on the way to the content recipients;
billing the content broadcaster for using the network content distribution service according to a flat rate plan, the flat rate plan at least covering the distribution made by multicast distribution.

2. The method of claim 1, wherein the content is streaming media.

3. The method of claim 1, wherein the method comprises optionally further billing the content broadcaster according to a usage based plan based on the extent of usage of the reserve distribution system.

4. The method of claim 1, wherein the reserve distribution system enables the multicast distribution to be made via best effort internet access network.

5. The method of claim 1, wherein less than 50% of bits sent to the service provider network are sent by the reserve distribution system.

6. The method of claim 1, wherein less than 20% of bits sent to the service provider network are sent by the reserve distribution system.

7. The method of claim 1, wherein the reserve distribution system comprises an alternative multicast distribution.

8. The method of claim 1, wherein the reserve distribution system comprises a loss resilient coding of said content.

9. The method of claim 1, wherein the reserve distribution system comprises distribution of loss resilient coding of said content by grid technology.

10. The method of claim 1, wherein the reserve distribution system comprises a retransmission facility for the content recipients to request packets lost in the multicast distribution.

11. The method of claim 1, wherein the reserve distribution system comprises content caching.

12. The method of claim 1, wherein the reserve distribution system enables the multicast distribution to be made via best effort internet access network and wherein the delivering content comprises distributing IP TV to the content recipients.

13. A method for improving cost-efficiency in delivering content from a content broadcaster to a service provider network, facilitating the service provider network to further distribute the content to content recipients; the method comprising
enabling multicast distribution within the service provider network and delivering said content to the service provider network by multicast distribution, thereby reducing costs of data transport to the service provider network; and
providing a reserve distribution system to handle delivery errors of content occurring on the way to the content recipients, thereby improving efficiency of the data transport to the service provider network.

14. The method of claim 13, wherein the content is streaming media.

15. The method of claim 13, wherein the reserve distribution system enables the multicast distribution to be made via best effort internet access network.

16. The method of claim 13, wherein less than 50% of bits sent to the service provider network are sent by the reserve distribution system.

17. The method of claim 13, wherein less than 20% of bits sent to the service provider network are sent by the reserve distribution system.

18. The method of claim 13, wherein the reserve distribution system comprises an alternative multicast distribution.

19. The method of claim 13, wherein the reserve distribution system comprises a loss resilient coding of said content.

20. The method of claim 13, wherein the reserve distribution system comprises distribution of loss resilient coding of said content by grid technology.

21. The method of claim 13, wherein the reserve distribution system comprises a retransmission facility for the content recipients to request packets lost in the multicast distribution.

22. The method of claim 13, wherein the reserve distribution system comprises content caching.

23. The method of claim 13, wherein the reserve distribution system enables the multicast distribution to be made via best effort internet access network and wherein the method for improving cost-efficiency is used for distributing IP TV to the content recipients.

24. A method of providing a network content distribution service for delivering content from a content broadcaster to a service provider network to facilitate the service provider network to further distribute the content to content recipients; the method comprising
establishing a network content distribution service comprising
delivering said content to a content cache connected to the service provider network, and
providing a reserve distribution system to handle delivery errors of content occurring on the way to the content recipients;
billing the content broadcaster for using the network content distribution service according to a flat rate plan, the flat rate plan at least covering distribution of the content from the content cache.

25. The method of claim 24, wherein the content is streaming media.

26. The method of claim 24, wherein the method comprises optionally further billing the content broadcaster according to a usage based plan based on the extent of usage of the reserve distribution system.

27. The method of claim 24, wherein the distribution of content from the content cache to the content recipients is made by multicast distribution.

28. The method of claim 24, wherein the distribution of content from the content cache to the content recipients is made by loss resilient grid technology.

29. The method of claim 24, wherein the reserve distribution system enables the multicast distribution to be made via best effort internet access network.

30. The method of claim 24, wherein the reserve distribution system comprises a multicast distribution.

31. The method of claim 24, wherein the reserve distribution system comprises a loss resilient coding of said content.

32. The method of claim 24, wherein the reserve distribution system comprises distribution of loss resilient coding of said content by grid technology.

33. The method of claim 24, wherein the reserve distribution system comprises a retransmission facility for the content recipients to request packets lost in the distribution from the content cache.
